(19) United States
(12) Patent Application Publication
(10) Pub. No.: US 2016/0037798 A1
(43) Pub. Date: Feb. 11, 2016

(54) DRY FOAM CONFECTIONERY PRODUCT

(71) Applicant: WM. WRIGLEY JR. COMPANY, Chicago (IL)

(72) Inventors: Scott G. BROWN, Oswego, IL (US); Gwendolyn GRAFF, Dekalb, IL (US); Joo SONG, Chicago, IL (US); April J. TACKETT, Chicago, IL (US)

(21) Appl. No.: 14/773,772

(22) PCT Filed: Mar. 12, 2014
(86) PCT No.: PCT/US14/24633

§ 371 Date: Sep. 9, 2015

Related U.S. Application Data
(60) Provisional application No. 61/781,923, filed on Mar. 14, 2013.

(51) Int. Cl. A23G 4/20; A23G 4/18; A23G 3/52; A23G 4/10

(52) U.S. Cl. CPC A23G 4/20; A23G 4/10; A23G 4/182; A23G 3/52; A23V 2002/00

(57) ABSTRACT

The present invention relates to a multiple portion confectionary product that has multiple textures and provides multiple sweetener release profiles and to the process for making the confectionary product. More specifically the invention relates to a multiple portion confectionary product wherein the confectionary product consists of a dry foam portion and a chewing gum portion.

### PRIORITY DATA

The present patent application is a 371 of International Application Ser. No. PCT/US14/24633 filed Mar. 12, 2014, which claims benefit from Ser. No. 61/781,923 filed Mar. 14, 2013, now expired. The applications listed above are incorporated by reference from as if entirely restated herein.

### BACKGROUND OF THE INVENTION

The present invention relates to a multiple portion confectionary product that has multiple textures and provides multiple sweetness release profiles, and to the process for making the confectionary product. More specifically the invention relates to a multiple portion confectionary product, wherein the confectionary product contains a dry foam portion and a chewing gum portion. The dry foam portion contains at least 80 wt. % bulking sweetener agent. The chewing gum portion contains chewing gum base. Preferably, the dry foam portion has an envelope density of less than 0.8 g/ml. Preferably, the chewing gum portion contains less than 30 wt. % bulking sweetener agent.

Several forms of confectionary products can deliver an initial fast release of sweetness and flavor upon first bite, such as after-dinner mints, or cotton candy. These products quickly dissolve and are then swallowed. These confectionary products are in a crystalline form with high surface area, either because of large individual crystals formed (e.g., after-dinner mints) or because of a large surface area formed (e.g., cotton candy). Other forms of confectionary products, such as chewy or toffee confections, can deliver sweetness and flavor for a longer duration time than after-dinner mints or cotton candy. However, chewy or toffee confections do not provide a fast initial release of flavor and sweetness.

Chewing gum products can be formulated to deliver sweetness and flavor over an extended period of time. The extended sweetness and flavor delivery is typically created by mixing gum base with bulking sweetener agent and flavors during the production of chewing gum products. The bulking sweetener agent and flavors are released in the mouth as the saliva mixes with the gum during chewing. Often, gum base, which is water insoluble, traps pockets of bulking sweetener agent and/or flavor, further slowing the release of sweetness and flavor. Encapsulants or other release modifiers can be used to further extend the release.

Chewing gum can be coated with a water soluble coating that can provide an initial fast release of sweetness and flavor. Many consumers enjoy the combination of a soft chewing gum center texture with a hard coating. When a coated chewing gum piece is consumed, the coating breaks into small pieces that can quickly dissolve providing an initial fast release of sweetness and flavor. The chewing gum center provides a more extended release of sweetness and flavor during chewing. A hard and brittle coating also provides a “crunch” sensation, which is both an audible and tactile sensation that many consumers enjoy. Typically, coatings are applied to chewing gum using a pan coating process.

In a typical pan coating process, a solution containing bulk sweetener, and optionally other ingredients such as flavors, is applied to the surface of chewing gum pieces. The solution can be applied using ladles, sprayers or other tools. The gum pieces are then allowed to dry to allow the solution to crystallize. The solution application and drying steps are performed repeatedly until the desired amount of coating is formed.

In pan coating, the chewing gum pieces are tumbled in a pan or drum. Tumbling helps distribute the coating material and allows each application to dry on to individual chewing gum pieces. However, the tumbling process limits the shape of the chewing gum pieces to rounded shapes or shapes with rounded corners, for example, balls, lentils or pillows. The pan coating process can also be time consuming and may be a rate-limiting step in the manufacture of coated chewing gum.

It would be useful to have a multiple portion confectionary product that provides multiple textures and delivers both an initial fast release of sweetness and flavor and an extended release of sweetness and flavor. It would be useful to have a process that would be capable of creating alternative forms of these multiple portion confectionary products.

### SUMMARY OF INVENTION

The present invention relates to a multiple portion confectionary product that has multiple textures and provides multiple sweetness release profiles, and to the process for making the confectionary product. More specifically the invention relates to a multiple portion confectionary product, wherein the confectionary product contains a dry foam portion and a chewing gum portion. The dry foam portion contains at least 80 wt. % bulking sweetener agent. The chewing gum portion contains chewing gum base. The dry foam portion has an envelope density of less than 0.8 g/ml.

### DETAILED DESCRIPTION OF INVENTION

The product of this invention comprises a dry foam portion of not less than 80 wt. % bulking sweetener agent and a chewing gum portion. In some embodiments, the dry foam portion has an envelope density of less than 0.8 g/ml. The process of this invention is a method of manufacturing the multiple portion confectionary product. The multiple portion confection of this invention may have one, or more than one, dry foam portion, and may have one, or more than one, chewing gum portion. The portions may be arranged within the final confectionary product in any arrangement. This invention is not limited by the number of dry foam portions, number of chewing gum portions, or their arrangement in relation to each other.

The product of this invention contains a dry foam portion. As used herein, “dry foam” means an aerated, firm, and spatially open, structure that contains less than 8 wt. % water. When used to describe the dry foam, “firm” means that the dry foam has a rigid texture at room temperature (i.e., 22-27 C), that is, it maintains its shape at room temperature. When used to describe the dry foam, “spatially open” means that the dry foam has multiple interior air cells.

The product of this invention contains a dry foam portion that contains less than 8 wt. % water. Water in the confection mass making up the dry foam portion may interfere with the crystallization of the bulking sweetener agent. Thus, the lower the moisture content is, the more crystalline the dry foam portion may be. The more crystalline the dry foam portion is, the more firm, brittle, crunchy, and soluble the dry foam may be. Thus, preferably, the dry foam portion contains less than 5 wt. % water. Most preferably, the dry foam portion contains less than 3 wt. % water.

The dry foam portion of this invention comprises at least 80 wt. % bulking sweetener agent. Bulking sweetener agent refers to an ingredient, or combination of ingredients, that provides mass and structure to a product and also imparts sweetness. Bulking sweetener agents include, but are not limited to, saccharides (for example, simple sugars, complex sugars, dextrins, maltodextrins, starches, modified starches, polydextrose, inulin, fructooligosaccharides), polyols, and combinations thereof. Bulking sweetener agents that melt, and then create firm amorphous or glass structures upon cooling to room temperature may be used in the dry foam portion, as long as air cells can be created during processing that will then become firm upon cooling to room temperature. Preferred are bulking sweetener agents that melt, and then create at least partially crystallized structures upon cooling to room temperature. Preferred bulking sweetener agents are also those that quickly dissolve so that a quick release of sweetness and flavor may develop during chewing. A product of this invention may contain more than one first portion, each having the same or different bulking sweetener agent or a combination of bulking sweetener agents. The dry foam portion of this invention comprises at least 80 wt. % bulking sweetener agent.

In an embodiment of the invention, the dry foam portion may also have an envelope density of less than 0.8 g/ml. The envelope density is a measure of the aeration of the dry foam portion. The envelope density of the dry foam portions of this invention were measured using a “granular sugar displacement method”, containing the steps of: 1) tare a 25 ml glass graduated cylinder; 2) weigh out 5 formed portions in the tarred graduated cylinder on a weight scale; 3) fill the graduated cylinder carefully with dry granular sugar until all 5 portions are covered with sugar; 4) tap the cylinder with 5 portions and granular sugar 10 times on padded table top; 5) adjust the sugar fill volume to cylinder's 25 ml mark; 6) remove the contents from the cylinder and then carefully separate sugar from portions; 7) return the granular sugar contents back to the cylinder; 8) record the volume (volume less than 25 ml, measured in ml) of the granular sugar contents from cylinder markings; and 9) calculate the portion envelope density: Mass of 5 formed portions (grams)÷Volume in cylinder difference between with and without 5 formed portions=Envelope density in g/ml.

Envelope density is the mass of the dry foam portion divided by the exterior dimensions of the dry foam portion. The area of the interior air cells is not part of the calculation. Whereas, the specific density of a dry foam portion is the mass of the confection portion divided by the area of the exterior volume minus the area of the interior volume of any air cells. If there are no interior air cells, then the envelope density would be the same as the specific density.

The more aerated the dry foam portion is, the lower the envelope density will be. The more aerated the dry foam, the faster the dry foam will dissolve in the mouth due to the greater surface area per gram of ingredients. Thus, a lower envelope density is preferred. Preferably, the dry foam portion has an envelope density of less than 0.5 g/ml. Most preferably, the dry foam portion has an envelope density of less than 0.3 g/ml.

The dry foam portion of the multiple portion confectionary product provides an initial fast release of sweetness and flavor when consumed. Optionally, the dry foam portion also imparts a “crunch” sensation when first bitten into, that is, an audible and tactile sensation. The release rate of sweetness by the dry foam portion will depend upon several factors; including the degree of aeration (as measured by envelope density), the amount of crystallinity, and the solubility of the bulking sweetener agent. In general, the more aerated the dry foam portion, the thinner the air cell walls and the more surface area created per gram of bulking sweetener agent. The bulking sweetener agent may be chosen such that under aeration conditions the bulking sweetener agent will form a firm amorphous or glass structure that is very soluble in saliva in the mouth. With the preferred bulking sweetener agents, this structure will also have a high level of crystallinity, which increases the fragility of the air cell walls. The choice of bulking sweetener agent affects the speed of the dry foam dissolving as each bulking agent has its own solubility. If flavor and/or other ingredients, such as, but not limited to, high intensity sweeteners (HIS), sensates, acids, salts, actives, and color, are also in the dry foam portion, then these ingredients will also have a fast release.

In an embodiment of the invention, a dry foam portion contains at least 80 wt. % bulking sweetener agent, preferably at least 90 wt. % bulking sweetener agent. The greater the percent of bulking sweetener agent in the dry foam portion, the greater the potential for a “crunch” texture and a fast release of sweetness during chewing.

In an embodiment of the invention, a chewing gum portion contains not more than 30 wt. % bulking sweetener agent, preferably not more than 10 wt. % bulking sweetener agent, most preferably not more than 5 wt. % bulking sweetener agent. Also, more bulking sweetener agent in the dry foam portion may lead to more bulking sweetener agent mixing with the chewing gum portion. The lower the bulking sweetener agent content in the chewing gum portion, the less gum portion mass needs to be applied on to the dry foam potion to achieve an elastic and cohesive finished product during chewing. In an embodiment of the invention, the bulking sweetener agent of a dry foam portion contains at least 30 wt. %, but not more than 100 wt. % isomalt. In an embodiment of the invention, the bulking sweetener agent of a dry foam portion contains at least 30 wt. %, but not more than 100 wt. % polydextrose. In an embodiment of the invention, the bulking sweetener agent of a dry foam portion contains 10 to 90 wt. % isomalt and 90 to 10 wt. % polydextrose.

The product of this invention contains a chewing gum portion. Chewing gum traditionally comprises two portions: a water soluble portion and a water insoluble portion. The water soluble portion includes bulking sweetener agents and optional additional ingredients such as, but not limited to, flavor, high intensity sweeteners (HIS), sensates, acids, salts, colors, and actives. The water insoluble portion includes chewing gum base and optional additional ingredients such as, but not limited, encapsulated flavors or sweeteners, fats, oils, waxes, and insoluble fillers (e.g. calcium carbonate). The term “chewing gum” includes bubble gum and similar products. As used herein, “chewing gum base” contains ingredients such as, but not limited to, elastomers, rubbers, fats, oils, softeners, fillers, and combinations thereof. The chewing gum base must contain at least one ingredient that will create an elastic texture during mastication.

The chewing gum portion may contain any amount of bulking sweetener agent. The chewing gum portion must contain at least some chewing gum base. Preferably, the chewing gum portion has at least 70 wt. % chewing gum base and not more than 30 wt. % bulking sweetener agent. The chewing gum portion may contain no bulking sweetener agent.

In an embodiment of the invention, a chewing gum portion contains at least 70 wt. % chewing gum base, and not more than 20 wt. % bulking sweetener agent. Preferably, a chewing gum portion contains not more than 10 wt. % bulking sweetener agent. More preferably, a chewing gum portion contains not more than 5 wt. % bulking sweetener agent. Most preferably, a chewing gum portion contains no bulking sweetener agent.

In an embodiment of the invention, a chewing gum portion contains polyvinyl acetate (PVAc) gum base.

In an embodiment of the invention, at least one chewing gum portion covers at least part of at least one dry foam portion. This arrangement enhances the mixing of the portions as the product is chewed, Because of this mixing during chewing, less bulking sweetener agent is needed in the chewing gum portion to make the chewing gum portion perceived as sweet by the consumer. An additional benefit of a chewing gum portion covering a dry foam portion is that the chewing gum portion can reduce moisture adsorption by the dry foam portion. Chewing gum is all, or mostly, made up of water insoluble ingredients, and so it may act as a barrier to moisture movement into the dry foam center portion from the environment, such as during storage.

The process of the invention includes the steps of: 1) creating a dry foam portion; 2) creating a chewing gum portion; and 3) combining the dry foam portion and the chewing gum portion. A further process step includes forming the combined portions into a shape. A further process step includes finishing the multiple portion confectionary product by processes including spraying with liquid ingredients, dusting with dry ingredients, or a combination thereof.

In general, the process of creating a dry foam portion includes the steps of: 1) creating a confectionary mass comprising at least 80 wt. % bulking sweetener agent; and 2) aerating the confection mass to an envelope density of less than 0.8 g/ml at room temperature (i.e., 22-27 C). Optionally, the dry foam may be cut and/or shaped into pieces. Also, optionally the dry foam pieces might be sprayed with liquid ingredients or dusted with dry ingredients.

The aerated dry foam portion may be produced by several processes including, but not limited to, aeration by combining a gas with the confection mass containing bulking sweetener agent, aeration by combining gas producing ingredients with the confection mass containing bulking sweetener agent, and aeration by evaporating the water within the confection mass containing bulking sweetener agent.

In an embodiment the invention is a process of creating a dry foam portion comprising the steps of: a) forming an ingredient mass comprising not less than 80 wt. % bulking sweetener agent; b) mixing and melting the ingredient mass to form a melted ingredient mass; c) mixing the melted ingredient mass with gas generating ingredients; and d) expanding the resultant mixed melted ingredient mass. Gas generating ingredients are compounds that are introduced to aerate the composition. The gas generating ingredient do not necessarily have to be introduced in gaseous form and may be a pressurized liquid or even dry ingredients that will generate gas. Examples of suitable gas generating ingredients include carbon dioxide, preferably super critical carbon dioxide, steam, nitrogen gas, air or any combination of gas generating ingredients.

In another embodiment, the method for creating a dry foam portion comprises the steps of 1) introducing an ingredient mass containing at least 80 wt. % bulking sweetener agent, along with optional additional ingredients, such as, but not limited to, HIS, colors, acids, actives, flavors, and sensates; 2) mixing and melting the ingredient mass; 3) introducing supercritical carbon dioxide; 4) mixing the melted ingredient mass with the carbon dioxide; 5) forcing the mixture through an opening and/or die under such temperature and pressure conditions as to create expansion of the ingredient mass; 6) dividing the expanded ingredient mass into portions; 7) optionally cooling the portions to sub-room temperature to reduce or prevent cell collapsing and/or product portions sticking to each other, and 8) tempering the portions to room temperature. The resulting portions contain less than 8 wt. % water. The resulting portions have an envelope density of less than 0.8 g/ml.

Supercritical carbon dioxide gas is carbon dioxide in a fluid state when it is held at, or above, its critical temperature (31° C.) and pressure (73 atm). In this fluid state, carbon dioxide is between a gas and a liquid. Supercritical carbon dioxide has a solvent character that can be used for extraction or as an aeration agent.

In an embodiment of this invention, a process of creating a dry foam portion comprises the steps of: 1) introducing an ingredient mass containing at least 80 wt. % bulking sweetener agent, along with optional additional ingredients, such as but not limited to HIS, colors, acids, actives, flavors, and sensates into at least one section of an apparatus; 2) mixing and melting the ingredient mass in the apparatus; 3) introducing nitrogen gas, air, steam, or combinations thereof into the apparatus; 4) mixing the melted ingredient mass with the nitrogen gas, air, steam, or combinations thereof, in the apparatus; 5) forcing the mixture from the apparatus through an opening and/or die located in a section of the apparatus under such temperature and pressure conditions as to create expansion of the ingredient mass upon exiting the apparatus opening and/or die; 6) dividing the expanded ingredient mass into portions after or as it exits the apparatus opening and/or die; 7) optionally cooling the portions to sub-room temperature to reduce or prevent cell collapsing and/or product portions sticking to each other, and 8) tempering the portions to room temperature. The resulting portions contain less than 8 wt. % water. The resulting portions have an envelope density of less than 0.8 g/ml.

In an embodiment of this invention, a process of creating a dry foam portion comprises the steps of: 1) introducing an ingredient mass containing at least 80 wt. % bulking sweetener agent, along with optional additional ingredients, such as, but not limited to, HIS, colors, acids, actives, flavors, and sensates into at least one section of an apparatus; 2) introducing gas generating ingredients (e.g., baking soda and acid) into the apparatus; 3) mixing and melting the ingredient mass in the apparatus; 4) providing time and agitation sufficient to create pressure within the apparatus; 5) forcing the mixture from the apparatus through an opening and/or die located in a section of the apparatus under such temperature and pressure conditions as to create expansion of the ingredient mass upon exiting the apparatus opening and/or die; 6) dividing the expanded ingredient mass into portions after or as it exits the opening and/or die: 7) optionally cooling the portions to sub-room temperature to reduce or prevent cell collapsing and/or product sticking to each other, and 8) tempering the portions to room temperature. The resulting portions contain less than 8 wt. % water. The resulting portions have an envelope density of less than 0.8 g/ml.

In an embodiment of this invention, a process of creating a dry foam portion comprises the steps of: 1) introducing an ingredient mass containing at least 80 wt. % bulking sweetener agent, along with optional additional ingredients, such as, but not limited to, HIS, colors, acids, actives, flavors, and sensates, into at least one section of an apparatus; 2) mixing and melting the ingredient mass in the apparatus; 3) forcing the mixture from the apparatus through an opening and/or die located in a section of the apparatus; 4) dividing the ingredient mass into portions after or as it exits the opening and/or die; 5) heating the exited portions at between 80-120° C. in a chamber under vacuum at between 15-30 in Hg until the portions have expanded to an envelope density of less than 0.8 g/ml; and 6) tempering expanded portions to room temperature. The resulting portions contain less than 8 wt. % water.

In any of the above embodiments, the apparatus used is such that it can mix, melt, and pressurize the ingredients introduced into the apparatus. The apparatus could be physically a single piece of equipment or multiple pieces of equipment used in sequence. The apparatus could be, or could include, a pressurized mixing bowl with appropriate entrance and exit sections. Preferably the apparatus is a single piece of equipment. Preferably, the apparatus has sub-sections that can be individually controlled as to temperature and mixing conditions, including pressure. Preferably, the apparatus also has entrance sections appropriate for adding different forms of ingredients, such as gas, powder, liquid, or combinations thereof. Preferably, the apparatus is, or includes, an extruder. An extruder is defined as an enclosed container with moving parts that mix ingredients under controlled heating conditions. An extruder has an entrance section for adding ingredients to the extruder and has an exit section with an opening and/or die for materials leaving the extruder. Preferably the extruder comprises a co-rotating intermeshing twin screw extruder. Preferably in the alternative, the extruder comprises a rotor and stator configuration. Preferably in the alternative, the extruder contains a “kneader” pin configuration. Preferably the extruder can create and/or maintain internal pressure.

In embodiment of the invention, a dry foam portion may be formed into different sizes, shapes, and densities using, but not limited to, rollers, knives, molds, rotary former, stamps, drop roller, or combinations thereof. In an embodiment of the invention a dry foam portion may be sprayed with fluid ingredients, dusted with solid ingredients, or combinations thereof.

The process of creating the chewing gum portion of this invention may be performed by any method known by one of ordinary skill in the art, including mixing, grinding, compacting, granularising, melting, pulling, extruding or combinations thereof. During processing the gum base may be combined with bulking sweetener agent and additional ingredients, and then the mass may be mixed, ground, compacted, granularised, melted, pulled, extruded or combination thereof. The chewing gum mass may then be formed into chewing gum portions. The chewing gum mass may be kept fluid until combined with a dry foam portion.

In an embodiment of the invention, a multiple portion confectionary product of this invention may be produced by combining at least one chewing gum portion with at least one dry foam portion by methods including, but not limited to, tumbling, moving, dragging, or combinations thereof, the dry foam portion through a pool of fluid chewing gum portion. “Combining” includes coating, surrounding, encasing, or layering.

In an embodiment of this invention, a multiple portion confectionary product may be produced by combining at least one chewing gum portion with at least one dry foam portion by methods including, but not limited to, spraying, pouring, dribbling, dripping or combinations thereof, the chewing gum portion on to the dry foam portion.

In an embodiment of the invention, a multiple portion confectionary product of this invention may be produced by combining a chewing gum portion with a dry foam portion by methods including co-extrusion technique. In the co-extrusion technique, a dry foam portion and a chewing gum portion are created at the same or similar time. The portions are then extruded through laminar or concentric slots in the co-extruder die, such that the chewing gum portion would be placed on, or around, at least a part of a dry foam portion. The resulting multiple portion confection may have the dry foam and chewing gum portions orientated laminar or concentric to each other.

In an embodiment of the multiple portion confectionary product invention, a chewing gum portion may cover all, or part of, the outer surface area of a dry foam portion. In an embodiment of the invention, a multiple portion confectionary product may contain one or more dry foam portions and one or more chewing gum portions.

In an embodiment of the invention, the multiple portion confectionary product may be formed into different sizes, shapes, and densities using, but not limited to, rollers, knives, molds, rotary former, stamps, drop roller, or combination thereof. In an embodiment of the invention, the multiple portion confectionary product is not limited in shape, size, weight, or volume. In an embodiment of the invention, a multiple portion confectionary product may be sprayed with fluid ingredients, dusted with solid ingredients, or combinations thereof.

In an embodiment of the invention, the multiple portion confectionary product may be deposited or placed into or onto packaging material to be sealed into individual or multiple piece packages.

### EXAMPLES

A multiple portion confectionary product sample, in accordance with the present invention was produced having a dry foam portion containing at least 80 wt. % bulking sweetener agent, and a chewing gum portion containing not more than 30 wt. % bulking sweetener agent. The multiple portion confectionary product was produced by creating dry foam portions (sample 1), then creating a chewing gum portion (sample 2), and finally combining the dry foam portions with the chewing gum portion into a combined multiple portion confectionary product (sample 3).

Table 1 includes the formula for the dry foam portion for sample 1. All components are in wt. % dry solids.

TABLE 1
Dry Foam Portion Formula Sample 1

| Sample # | Isomalt | Polydextrose | HIS* | Spray dried/capsule flavor |
|---|---|---|---|---|
| 1 | 33.89% | 62.94% | .0.26% | 2.91% |

*HIS = high intensity sweeteners

The dry foam portion of sample 1 was processed in accordance with the supercritical carbon dioxide process as previously described, under the conditions set forth in Table 2.

TABLE 2
Dry Foam Portion Process Sample 1.

| Sample | Sections | Sections | Sections | Sections | Section/Die | |
|---|---|---|---|---|---|---|
| # | 1-2 | 3-4 | 5-7 | 8-9 | 10/Die | Results Description: |
| 1 | 50- | 160- | 100- | 85- | 85- | Good expanded portions; |
| | 100 C. | 130 C. | 90 C. | 95 C. | 95 C. | Controlled and stable flow; Die fly |
| | | | | | | knife cutter was used (400 rpm); |
| | | | | | | Extruder screw (speed 80 rpm); |
| | | | | | | Powder Feeder (speed 100 rpm}; |
| | | | | | | Supercritical Carbon Dioxide |
| | | | | | | (1.5 ml/min; 80 g/min) |

A confection mass containing the bulking sweetener agent and additional ingredients listed in Table 1 was processed in a 10 section Coperion ZSK-25; co-rotating intermeshing twin screw extruder. The temperature conditions in the sections are listed in Table 2.

The confection mass of Table 1 was pre-mixed and added to the first section of the extruder. The confection mass was then further mixed and conveyed by the twin screws through sections 2 to 10, and then out of the extruder through a die plate with a hole in it. The confection mass was heated and then cooled as it was conveyed through the extruder according to the temperatures listed in Table 2. When the confection mass melted, fluid supercritical carbon dioxide was injected in to the extruder. The fluid supercritical carbon dioxide intermixed with and dissolved in the melted confection mass. The intermixed mass was conveyed through the cooler extruder sections and then out of the extruder through the die plate. The temperature and mixing conditions were such that sufficient pressure was created in the extruder to allow the supercritical carbon dioxide to remain fluid in the extruder. The pressure created in the extruder was also sufficient to force the confection mass through the die plate.

When the confection mass exited the extruder die plate in to ambient temperature and atmospheric pressure, the carbon dioxide in the confection mass expanded, expanding the confection mass around it. As the confection mass exited the extruder die plate, the confection mass started to cool and become firm. The net result was that the expanded confection mass maintained its expanded shape upon reaching room temperature, that is, the confection mass became a dry foam portion. A fly knife was positioned exterior to the die plate and cut the extruding confection mass into small pieces as the mass exited the die plate.

The “Results Description” in Table 2 describes the exiting dry foam portions formed and the exiting process character. The formed dry foam portions of sample 1 had an envelope density of approximately 0.22 g/ml.

A chewing gum portion (sample 2) was produced by mixing and heating the chewing gum ingredients listed in Table 3 until well mixed and fluid.

TABLE 3
Chewing Gum Portion Formula Sample 2

| Sample # | Chewing Gum Base | HIS* | Color |
|---|---|---|---|
| 2 | 99.78% | 0.19% | 0.03% |

*HIS = high intensity sweetener

A multiple portion confectionary product (sample 3) was then produced by combining the dry foam portions (sample 1) with the chewing gum portions (sample 2). The dry foam portions were combined with the chewing gum portions by dipping and dragging the dry foam portions through a pool of fluid chewing gum portion. The combined multiple portion confectionary product samples were then allowed to cool to room temperature.

The resulting multiple portion confectionary product samples were perceived as having a crunchy texture with an initial fast release of flavor and sweetener when chewed. The multiple portion confectionary product samples also had a residual (i.e., gum cud) similar to that of a chewing gum piece of equal volume made by a traditional chewing gum process.

The compositions and methods of the present invention are capable of being incorporated in the form of a variety of embodiments, only a few of which have been illustrated and described. The invention may be embodied in other forms without departing from its spirit or essential characteristics. The described embodiments are to be considered in all respects only as illustrative and not restrictive, and the scope of the invention, therefore, is indicated by the appended claims rather than by the foregoing description. All changes which come within the meaning and range of equivalency of the claims are to be embraced within their scope.

What is claimed is:

1. A confectionary product comprising:
a) a dry foam portion comprising of not less than 80 wt. % bulking sweetener agent; and
b) a chewing gum portion.

2. The confectionary product of claim 1, wherein the dry foam portion has an envelope density of less than 0.8 g/ml.

3. The confectionary product of claim 1, wherein the dry foam portion has an envelope density of less than 0.5 g/ml.

4. The confectionary product of claim 1, wherein the dry foam portion has an envelope density of less than 0.3 g/ml.

5. The confectionary product of claim 1, wherein a dry foam portion comprises less than 8 wt. % water.

6. The confectionary product of claim 1, wherein a dry foam portion comprises less than 5 wt. % water.

7. The confectionary product of claim 1, wherein a dry foam portion comprises less than 3 wt. % water.

8. The confectionary product of any one of the previous claims, wherein the bulking sweetener agent in the dry foam portion comprises at least 30 wt. %, but not more than 100 wt. % polydextrose.

9. The confectionary product of any one of the previous claims, wherein the bulking sweetener agent in the dry foam portion comprises 10-90 wt. % isomalt.

10. The confectionary product of any one of the previous claims, wherein the bulking sweetener agent in the dry foam portion contains 30-100 wt. % polydextrose.

11. The confectionary product of any one of the previous claims, wherein the chewing gum portion contains not less than 50 wt. % gum base.

12. The confectionary product of any one of the previous claims, wherein the chewing gum portion contains not less than 70 wt. % gum base.

13. The confectionary product of any one of the previous claims, wherein the chewing gum portion contains not less than 80 wt. % gum base.

14. The confectionary product of any one of the previous claims, wherein the chewing gum portion contains not less than 90 wt. % gum base.

15. The confectionary product of any one of the previous claims, wherein the chewing gum portion contains not more than 10 wt. % bulking sweetener agent.

16. The confectionary product of any one of the previous claims, wherein the chewing gum portion contains not more than 5 wt. % bulking sweetener agent.

17. The A confectionary product of any one of the previous claims, wherein the chewing gum portion contains polyvinyl acetate.

18. The confectionary product of any one of the previous claims, wherein the chewing gum portion covers at least part of a dry foam portion.

20. The method of producing a multiple portion confectionary product comprising the steps of:
a) producing a dry foam portion;
b) producing a chewing gum portion; and
c) combining the dry foam portion and the chewing gum portion.

21. The method of claim 20, wherein the chewing gum portion is combined with the dry foam portion by a process of spraying, pouring, dripping, or combinations thereof.

22. The method of claim 20, wherein the chewing gum portion is combined with the dry foam portion by a process of tumbling, moving, dragging, or combinations thereof.

23. The method of claim 20, wherein the chewing gum portion is combined with a dry foam portion by co-extrusion.

24. The method of any one of claims 20-23, further including the step of forming the combined multiple portion confectionary product into shapes, including but not limited to sticks, tabs, balls, or ropes.

25. The method of any one of claims 20-24, further including the step of finishing the combined multiple portion confectionary product by spraying confection with liquid ingredients, dusting confection with dry ingredients, or combinations thereof.

26. The method of any one of claims 20-25, wherein the dry foam portion comprises not less than 80 wt. % bulking sweetener agent.

27. The method of any one of claims 20-25, wherein the dry foam portion comprises not less than 90 wt. % bulking sweetener agent.

28. The method of any one of claims 20-27, wherein the chewing gum portion comprises not more than 10 wt. % bulking sweetener agent.

29. The method of any one of claims 20-27, wherein the chewing gum portion comprises not more than 5 wt. % bulking sweetener agent.

30. The method of any of claims 20-29, wherein the chewing gum portion comprises not less than 80 wt. % gum base.

31. The method of producing a dry foam portion comprising the steps of:
a) forming an ingredient mass comprising not less than 80 wt. % bulking sweetener agent;
b) mixing and melting the ingredient mass to form a melted ingredient mass;
c) mixing the melted ingredient mass with gas and/or gas generating ingredients; and
d) expanding the resultant mixed melted ingredient mass.

32. The method of claim 31 wherein the gas generating ingredients comprises super critical carbon dioxide.

33. The method of claim 31 wherein the gas generating ingredients comprise an ingredient selected from the group consisting of nitrogen gas, air, steam or combinations thereof.

34. The method of any of claims 31-33 wherein the step of mixing the melted ingredient mass with the gas generating ingredients is performed at an elevated pressure.

35. The method of any of claims 31-34 wherein the step of expanding the resultant mixed melted ingredient mass comprises the step of forcing the mixed melted ingredient mass through an opening and/or die under such temperature and pressure conditions as to create expansion of the mixed melted ingredient mass upon exiting the opening and/or die.

36. The method of any of claims 31-35 wherein the step of expanding the resultant mixed melted ingredient mass comprises the step of applying a vacuum of between 15-30 inches Hg and a temperature of 80-120° C. to the mixed melted ingredient mass.

37. The method of any of claims 31-36 wherein the mixed melted ingredient mass is expanded to an envelope density of less than 0.8 g/ml.

38. The method of any of claims 31-37 wherein the mixed melted ingredient mass is expanded to an envelope density of less than 0.5 g/ml.

39. The method of any of claims 31-38 wherein the mixed melted ingredient mass is expanded to an envelope density of less than 0.3 g/ml.

40. The method of any of claims 31-39, wherein at least a portion of the method is performed using an extruder.

41. The method of claim 40, wherein the extruder comprises a co-rotating intermeshing twin screw.

42. The method of claim 40, wherein the extruder comprises a rotor and stator configuration.

43. The method of claim 40, wherein the extruder comprises a kneader pin configuration.

44. The method of any one of claims 31-43, further including the step of finishing the dry foam portion by spraying with liquid ingredients, dusting with dry ingredients, or a combination thereof.

45. The method of any one of claims 31-44, further including the step of forming the dry foam portion into different sizes, shapes, or densities using rollers, knives, molds, rotary former, stamps, drop roller, or combination thereof.
